(19) United States
(12) Patent Application Publication
(10) Pub. No.: US 2012/0011465 A1
(43) Pub. Date: Jan. 12, 2012

(54) DIGITAL WHITEBOARD SYSTEM

(76) Inventor: Marcelo Amaral Rezende, Florianopolis (BR)

(21) Appl. No.: 13/156,023

(22) Filed: Jun. 8, 2011

Related U.S. Application Data
(60) Provisional application No. 61/398,892, filed on Jul. 6, 2010.

(51) Int. Cl. G06F 3/048

(52) U.S. Cl. 715/786

(57) ABSTRACT

A digital whiteboard system for enabling a user thereof to write at a preferred position includes a digital whiteboard configured to cooperate with a computer, said digital whiteboard, in operation, being divided into a plurality of virtual panels; wherein the digital whiteboard locates tools and menu bar; wherein the digital whiteboard is configured to allow a user to move a virtual panel upwards or downwards by dragging a continuous scroll bar; and wherein the virtual panel moves in the same direction as the direction in which the scroll bar is dragged.

### RELATED APPLICATIONS

This application claims the benefit of the priority date of U.S. Provisional Application 61/398,892, filed on Jul. 6, 2010, the contents of which are herein incorporated by reference.

### FIELD OF DISCLOSURE

This disclosure relates to displays, and in particular, to whiteboards.

### BACKGROUND

A digital whiteboards, sometimes called an interactive whiteboard, is a large computer screen or a projected image thereof on which a teacher can simulate control of a mouse using finger gestures or by moving a special stylus or any type of object on top of the projected image or screen. Generally, these images and screens are quite large. A typical digital whiteboard is approximately 1.2 meters high and 1.6 meters wide, which results in an approximately 80 inch screen. In some cases, digital whiteboards are even larger.

Digital whiteboards are often used in educational settings, where they replace chalk based blackboards and conventional whiteboards. The digital whiteboard is among the teacher's most important tools.

A difficulty that arises with digital whiteboards comes from their limited size. Teachers usually require a minimum of a four meter length board for each half-hour teaching. During this teaching session, the teacher can fill an entire board with annotations and notes.

Conventional digital whiteboards are limited in size because most computer applications place toolbars across the top of the display. Although accessible on a conventional computer display, these tools are often out of the teacher's reach. As a result, digital whiteboards are often of limited height, typically less than 1.90 meters.

To maintain its to edge within a teacher's typical reach, which is around 1.9 meters, a digital whiteboard with dimensions as specified above, would be placed 70 cm from the floor. This placement results in the following difficulties:

First, most of the whiteboard will be so low that it cannot be seen by the entire classroom.

Secondly, many teaches will find themselves standing in front of the projector while writing, and casting a shadow. As a result, these teachers will not be able to see their own handwriting.

Thirdly, when the teacher turns around to face the students, the glare from the projector light can be uncomfortable.

Finally, most teachers will find it comfortable to write on a limited portion of the whiteboard, typically in a narrow band of between 20-30 cm at eye level. In a digital whiteboard having the dimensions specified above, the teacher would have only 0.5 square meters of whiteboard area that can conveniently be written on. In most cases, this is not enough for a teacher to work with.

The foregoing difficulties disappear to some extent when the whiteboard is raised, as shown in FIG. 1. However, when the whiteboard is raised, the teacher cannot easily write on it the upper reaches thereof. One can avoid this difficulty by providing multiple panels with tracks that enable the panels to move up and down. However, this can be an expensive and troublesome option.

### SUMMARY

The present invention provides a digital whiteboard interface that allows a digital whiteboard to more closely simulate a regular whiteboard, but with the addition of a fully functional virtual personal computer interface. This virtual personal computer interface can be moved or resized as any computer application on this virtual whiteboard.

Additionally, a mouse pointer that works as an absolute pointer position or a relative pointer position can be used. The change from one to the other can be made by clicking a mouse button or a virtual button, for instance, by clicking on an icon or by a gesturing in a particular way. The availability of a mouse is useful for a large digital whiteboards where some icons are out of the teacher's reach.

In one aspect, the invention features a digital whiteboard system for enabling a user thereof to write at a preferred position. Such a system includes a digital whiteboard configured to cooperate with a computer, said digital whiteboard, in operation, being divided into a plurality of virtual panels; wherein the digital whiteboard locates tools and menu bar; wherein the digital whiteboard is configured to allow a user to move a virtual panel upwards or downwards by dragging a continuous scroll bar; and wherein the virtual panel moves in the same direction as the direction in which the scroll bar is dragged.

Embodiments of the invention also include those in which the scroll bar divides the virtual panel in rectangles, those in which the scroll bar moves the virtual panel laterally, and those in which the digital whiteboard is configured to display a window on which is a copy of a display from the computer.

Among the embodiments of the invention are those that also include a mouse that switches between operating as an absolute pointer position and operating as a relative pointer position similar.

These and other features of the invention will be apparent from the following description and the attached figures, in which:

### BRIEF DESCRIPTION OF THE FIGURES

FIG. 1 compares a prior art whiteboard with an improved whiteboard system as described herein;

FIG. 2 illustrates how the virtual panel moves on the same direction in which the scroll bar is dragged;

FIG. 3 is a second schematic figure of a virtual panel;

FIG. 4 illustrates a switch between operation as a mouse pointer and operation as a pen;

FIG. 5 shows a typical display;

FIG. 6 shows a double-screen embodiment;

FIG. 7 shows the position of the computer interface on several digital whiteboards;

FIG. 8 shows a digital whiteboard mounted on a wall;

FIG. 9 shows sight-lines for a digital whiteboard and

FIG. 10 shows another digital whiteboard.

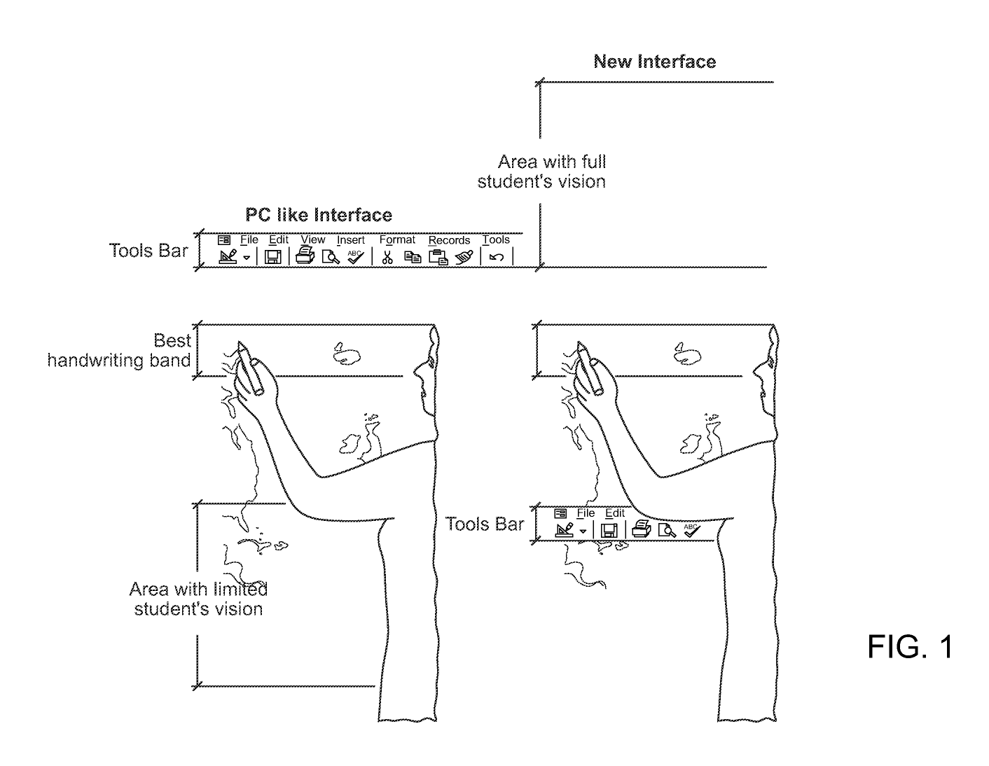

### DETAILED DESCRIPTION

The present invention includes a digital whiteboard that cooperates with a computer. The digital whiteboard locates tools and menu bar within reach of teacher's hands. These tools could be located at the bottom of the screen, or at its sides, or floating over the screen.

Many conventional whiteboards feature multiple panels that move up and down on rails or tracks. The digital whiteboard described herein emulates such whiteboards.

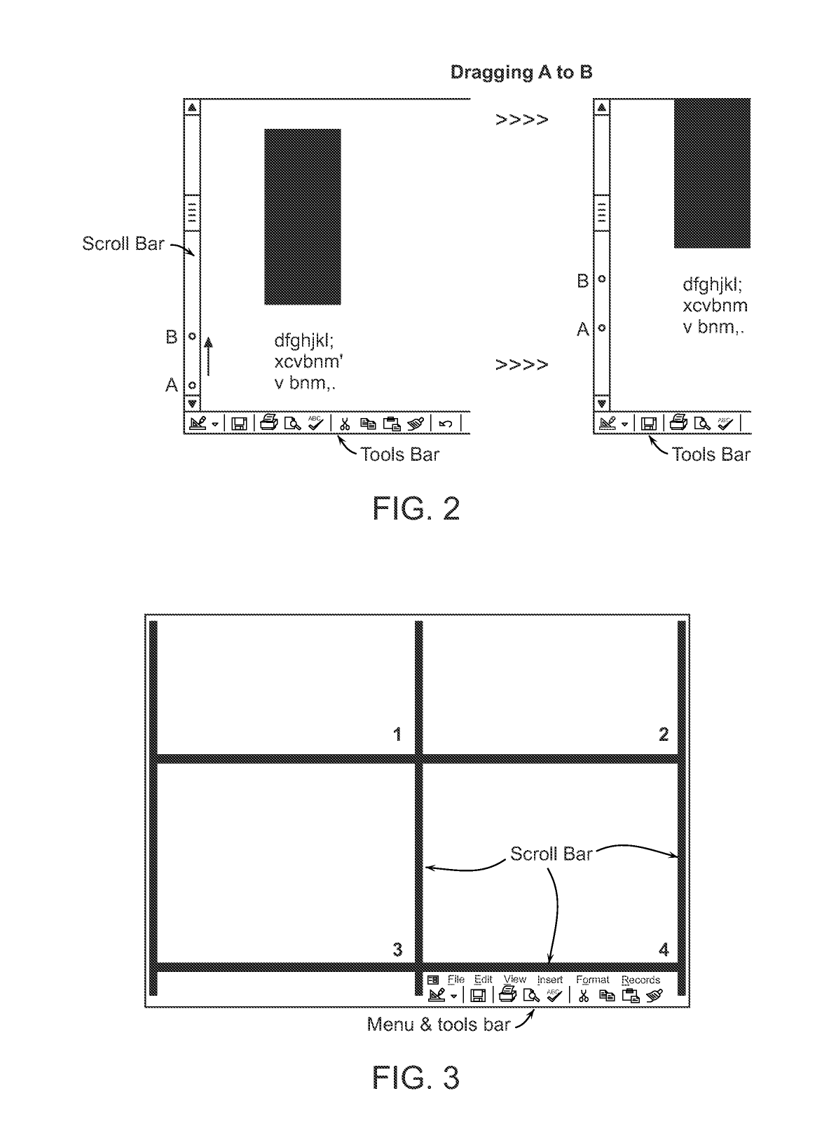

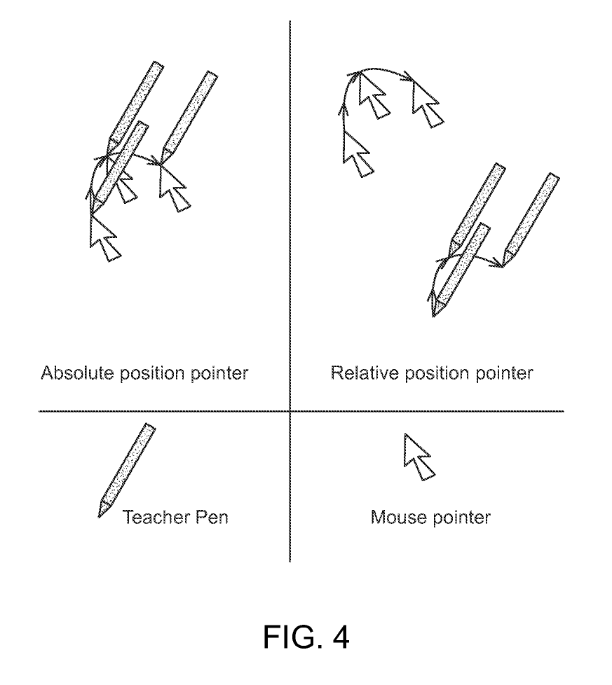

The teacher can keep a virtual panel of the digital whiteboard at a preferred height for handwriting by moving the virtual panel upwards or downwards. This can be done by dragging a continuous scroll bar that operates in a manner opposite to how a conventional scroll bar operates. In particular, the virtual panel moves in the same direction as the direction in which the scroll bar is dragged, as shown in FIG. 2. The scroll bar itself can be moved to different locations on the whiteboard, so that the teacher can set the scrollbar to be at an ergonomically preferred location.

As an alternative to, or in addition to a vertical scroll bar, the digital whiteboard can also display a horizontal scroll bar. The horizontal scrollbar can help the teacher organize the board. Using appropriate pre-defined gestures, a teacher can place a scroll bar at any place of the digital whiteboard. As a result, a teacher can move a virtual panel in the same way that they would move a panel in a real movable whiteboard.

In a 2.4×1.6 meter digital whiteboard, the scroll bars may divide a panel into rectangles of 1.2×0.8 meters. By dragging vertical scroll bars, the teacher can set the virtual panel at best height. By dragging a horizontal scrollbar, if one is available, the teacher can adjust the lateral position of the panel.

In general, the top edge of the digital whiteboard can be as high as 2.2 meters high or more above the floor. As a result, it will be impossible for a teacher to operate most computer applications displayed in a conventional way as a projected image on a whiteboard because the menu extending across the top of the whiteboard would be out of their reach.

To solve the foregoing problem, one can provide a mouse that can switch between being an absolute pointer, like a standard pointer on a digital whiteboard, and being a relative pointer, similar to a standard pointer on a computer. To switch between these two operating modes, the user-interface on the digital whiteboard provides an icon on a menu bar or toolbar or anywhere else on the digital whiteboard. If the teacher actuates this icon, the mouse switches from one mode to another. This switching function can also be implemented by a button on the pointer.

When used as an absolute pointer, the teacher can, for instance, easily write notes or control tools that are nearby. On the other hand, when used as a relative pointer, a teacher can reach, with the pointer, an icon that would normally be out of reach just by moving the mouse on a nearby virtual mouse pad, exactly as he would on a conventional computer interface. In either case, the mouse down status could be done by a gesture, for example by tapping the digital whiteboard twice in the same location.

Another way to provide the teacher with the necessary reach would be to provide an icon that, when pressed, causes a new window to appear. This new window shows a copy of the computer screen without the whiteboard interface. The teacher could then access the virtual computer screen and all its functions. This would include moving the mouse pointer around this virtual screen and controlling the computer's functionality.

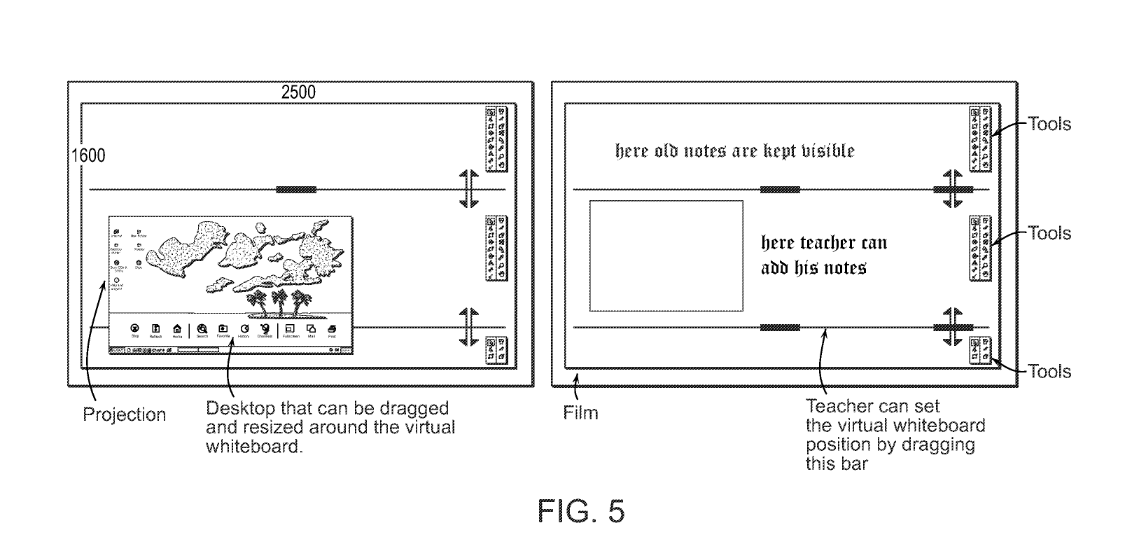

The foregoing virtual computer screen can be moved around the digital whiteboard, as well as resized as other computer windows. Teachers can thus play videos or show presentations on the digital whiteboard as they make annotations near the virtual computer screen. For example, a teacher can copy a map from this virtual computer and paste it into the digital whiteboard, as shown in FIG. 5.

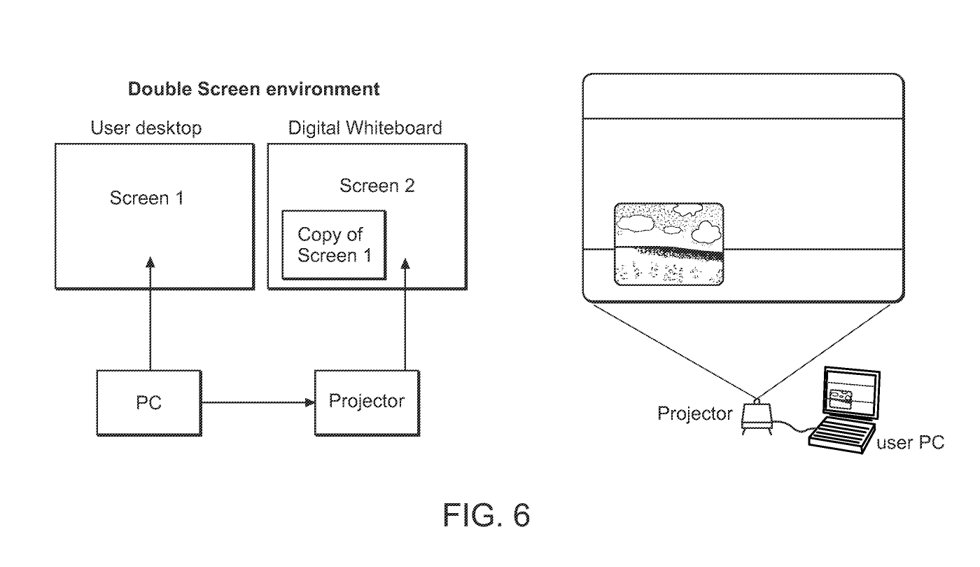

In a dual screen, as shown in FIG. 6, a digital whiteboard application appears in a secondary screen and the virtual computer, which is a copy of the main screen with an invisible layer set over it to control the mouse position, appears on a primary screen. The digital whiteboard system permits use of both the foregoing solutions, so that the teacher can select his favorite one.

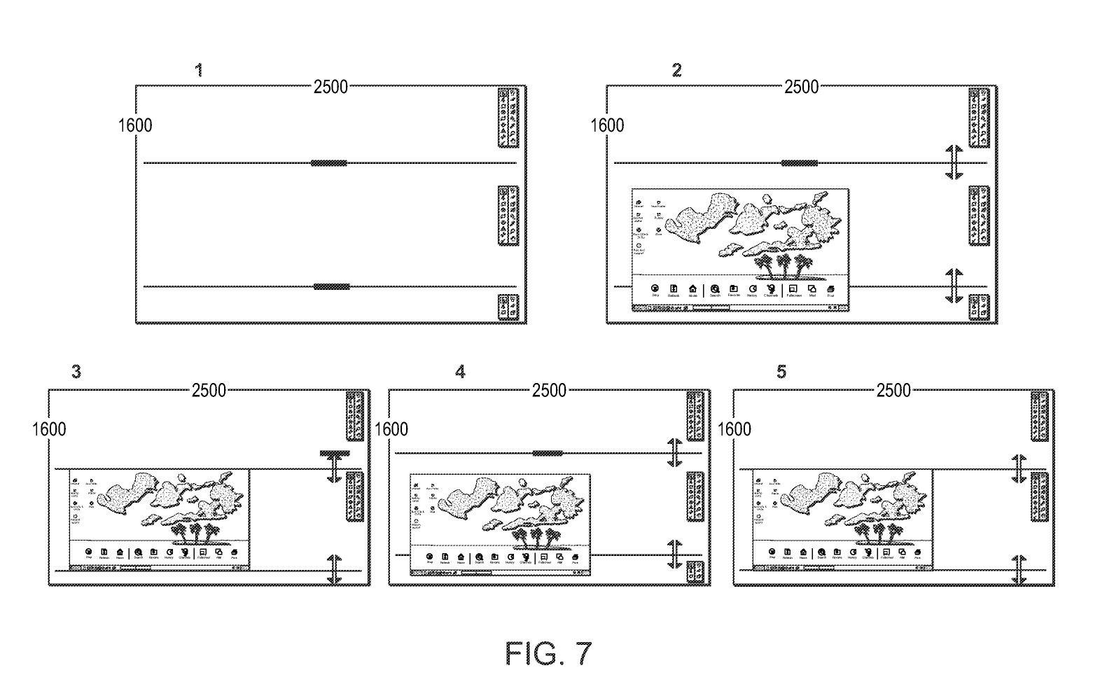

As an example, picture (1) in FIG. 7 shows a proposed system for a 2.5×1.6 meter digital whiteboard. The scroll bar is located at a vertical line that divides the whiteboard into two 0.8×2.5 meter rectangular panels. A copy of the menu or tool bar is located on the right side, one in each rectangular panel.

In picture (2) of FIG. 7, a virtual computer screen has been added to the digital whiteboard. Pictures (3), (4), and (5) of FIG. 7 show how a panel can be moved upwards or downwards.

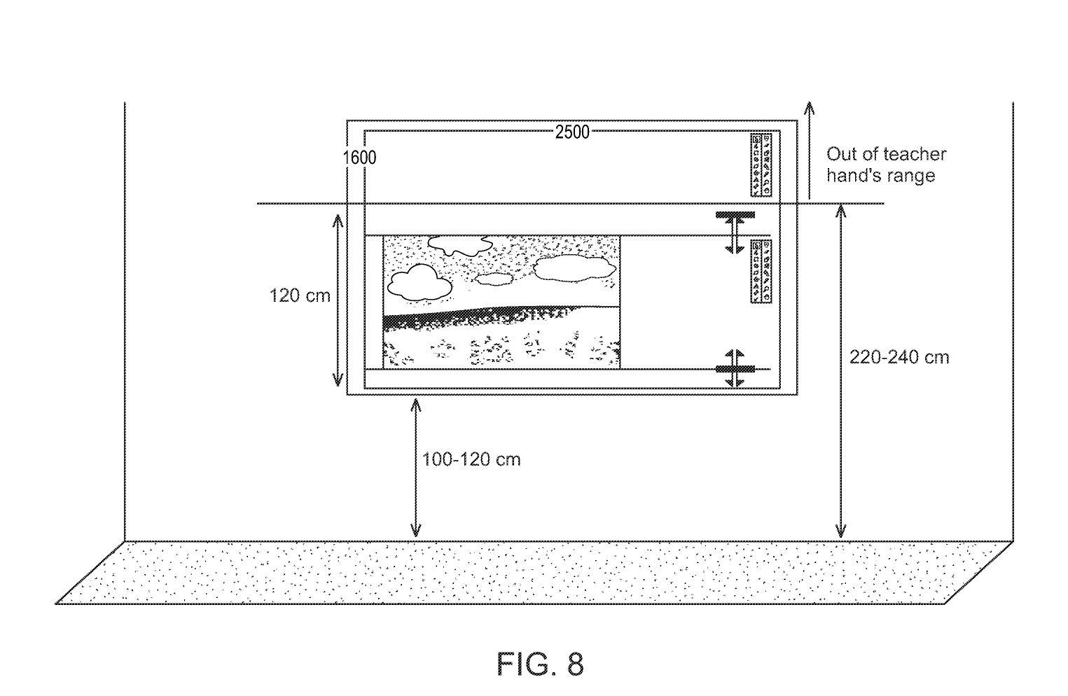

FIG. 8 shows how a digital whiteboard can be mounted on a wall in a classroom. The outer frame is the whiteboard's boundary. The inner frame is the boundary of the projected image on the digital whiteboard. The height of this boundary can be adjusted by changing the projector angle.

In most cases, the main cost of a digital whiteboard system is the electronics behind the board itself. The cost of this board is thus proportional to its area. Using a system as described herein provides a way to reduce this cost. In particular, since the teacher will not need to use the absolute position mouse pointer, nor be able to handwrite on the whole board, and because more of the digital whiteboard would be beyond a teacher's reach anyway, those out-of-reach areas of a whiteboard need not have any electronics behind them. As a result, it becomes possible to produce a bigger digital whiteboard without increasing its price.

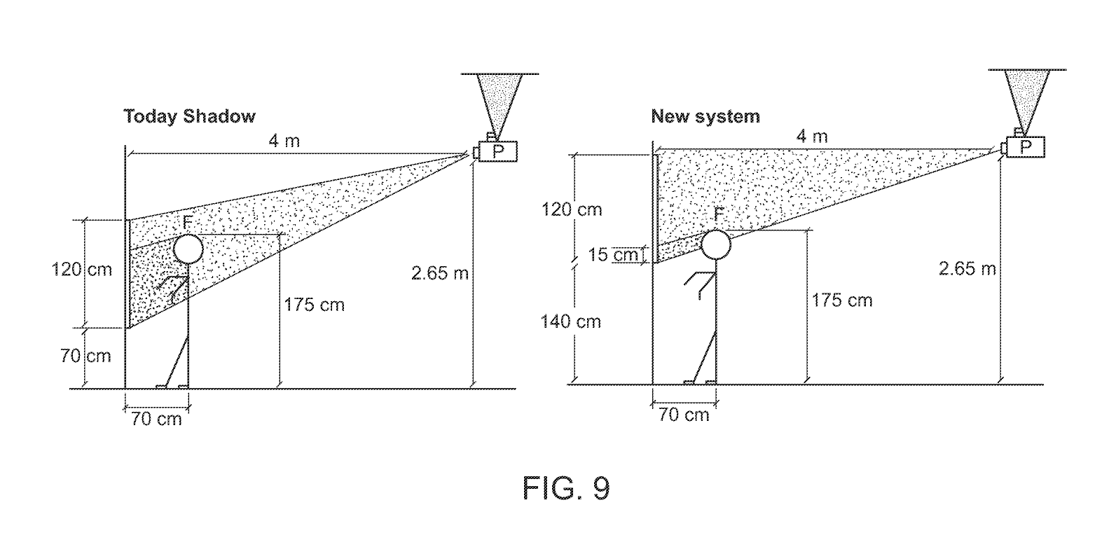

FIG. 9 shows how the digital whiteboard system described herein reduces the area of the shadow cast by a teacher on a digital whiteboard as a consequence of front projection.

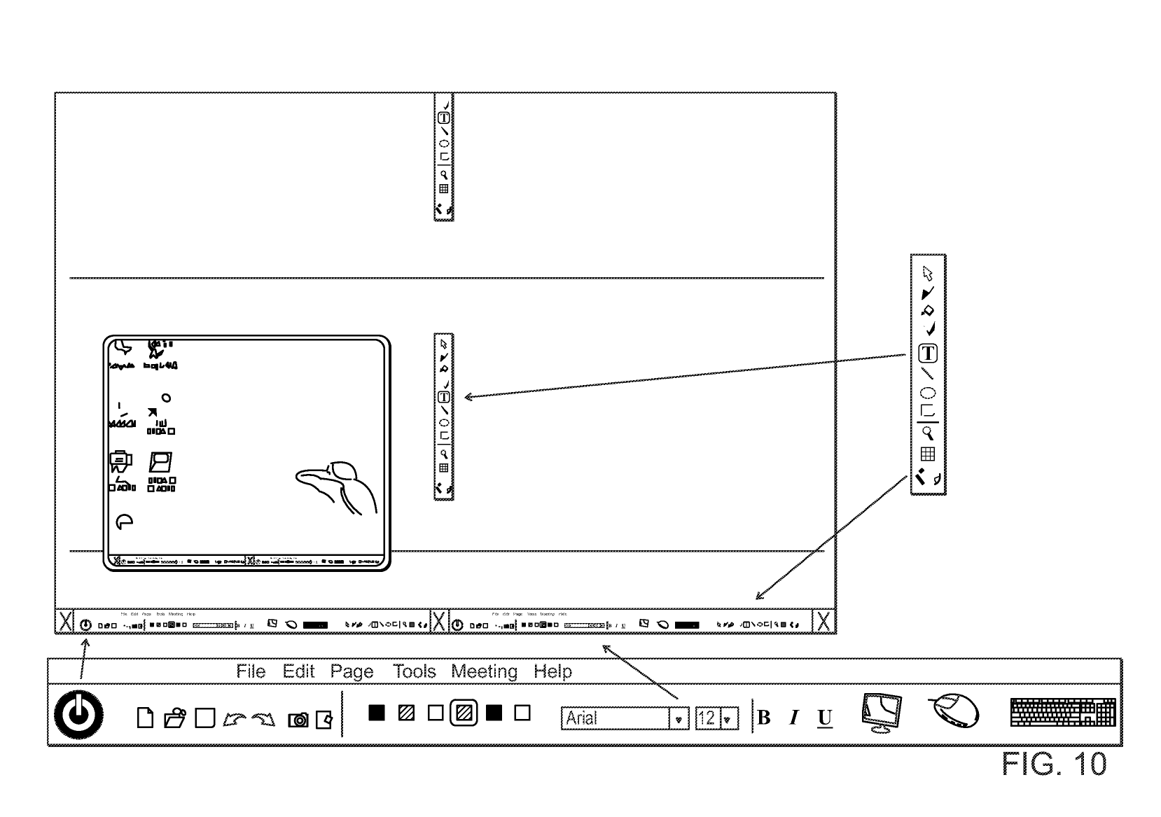

FIG. 10 presents a more detailed view of the digital whiteboard system showing the menu and tool bar in more detail.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A digital whiteboard system for enabling a user thereof to write at a preferred position, said system comprising:
a digital whiteboard configured to cooperate with a computer, said digital whiteboard, in operation, being divided into a plurality of virtual panels;
wherein the digital whiteboard locates tools and menu bar;
wherein the digital whiteboard is configured to allow a user to move a virtual panel upwards or downwards by dragging a continuous scroll bar; and
wherein the virtual panel moves in the same direction as the direction in which the scroll bar is dragged.

2. The system of claim 1, wherein the scroll bar divides the virtual panel in rectangles.

3. The system of claim 1, wherein the scroll bar moves the virtual panel laterally.

4. The system of claim 1, further comprising a mouse that switches between operating as an absolute pointer position and operating as a relative pointer position similar.

5. The system of claim 1, wherein the digital whiteboard is configured to display a window on which is a copy of a display from the computer.
